(19) United States
(12) Patent Application Publication
(10) Pub. No.: US 2004/0262085 A1
(43) Pub. Date: Dec. 30, 2004

(54) Sensor arrangement for a measurement of the travel of a moving component of a mechanical device

(76) Inventor: Gerold Mueller, Stuttgart (DE)

Correspondence Address: Striker Striker & Stenby, 103 East Neck Road, Huntington, NY, 11743, US

(21) Appl. No.: 10/493,920

(22) PCT Filed: Oct. 18, 2002
(86) PCT No.: PCT/DE02/03938

(30) Foreign Application Priority Data
Oct. 30, 2001 (DE) 101 53 531.7

(51) Int. Cl. B66F 9/06

(52) U.S. Cl. 187/222

(57) ABSTRACT

A sensor arrangement for measuring the deflection of a moving part of a mechanical device, e.g., a lifting device for a fork lift, is disclosed, with which one part (13) of the contactless sensor arrangement is attached to the moving part (4), and another part (12) of the sensor arrangement is attached at a reference point for the device (2). A radar transmitter (12) with an integrated radar sensor is attached at the reference point of the device, and a reflector device (13) for reflecting the radar beams from the radar transmitter (12) to the radar sensor (12) is provided on the moving part (4), whereby the path of deflection of the moving part (4) of the mechanical device (2) is capable of being determined from the transit time of the radar beams.

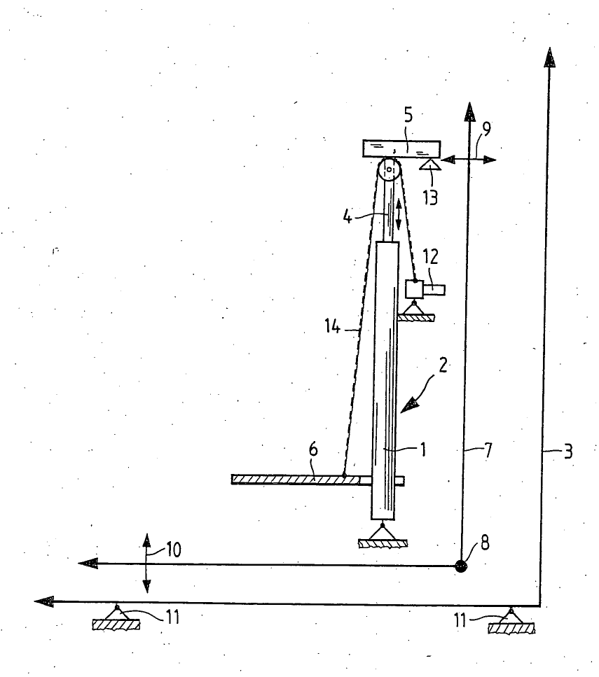

### BACKGROUND INFORMATION

The present invention relates to a sensor arrangement for measuring the deflection of a moving part of a mechanical device, in particular for measuring the lift height of a cylinder for lifting and lowering the fork of an industrial conveying vehicle, according to the general class of the main claim.

It is made known in EP 1 079 118 A2, for example, that, with a hydraulically moved cylinder, the distance between a point on the moving cylinder and a fixed reference point is detected using an ultrasonic sensor arrangement. To accomplish this, an ultrasonic transmitter is mounted on one end, and an ultrasonic sensor is mounted on the other end, so that a lift height, for example, can be measured based on the transit time of the ultrasonic wave. To improve the measured result, the measured signal is corrected using detected values for temperature and the pressure of the hydraulic fluid in the lift cylinder.

The primary disadvantage of this sensor arrangement is that an application in vehicles such as industrial conveying vehicles (fork lifts) is typically not a consideration, because the ultrasonic useful signal is greatly disturbed by wind influences and loud noises from the vehicle.

Further alternatives for measuring a lift height that are known per se would be, for example, measuring the lift deflection using a cable-tension potentiometer or a laser range finder, whereby these measurement methods are either mechanically very sensitive or very susceptible to interference, e.g., by contamination or overload. Pressure measurements alone in a hydraulic system with an extendable cylinder, e.g, for measuring lift in cylinders in a telescope mast, are often not usable, either, because a sensor is required in each cylinder of a duplex or triplex mast, and a complex trailing cable is required. In addition, a direct statement about height cannot be made based on the pressure measurement.

Considered in and of itself, it is made known in DE 42 42 700 A1, for example, that, to detect the distance and the relative velocity of a vehicle traveling in front, a radar sensor for evaluating a reflected radar signal in the microwave range is mounted on the bumper of a motor vehicle [a radar transmitter and a radar receiver as the sensor].

### ADVANTAGES OF THE INVENTION

The sensor arrangement for measuring the deflection of a moving part of a mechanical device according to the type indicated initially is developed further in accordance with the invention. Advantageously, a radar transmitter and a radar sensor are attached at the reference point of the device, and a reflecting device, e.g., a triple reflector, is provided on the moving part to reflect the radar beams from the radar transmitter to the radar sensor, whereby the path of the deflection of the moving part of the mechanical device is capable of being determined based on the transit time of the radar beams. It is also possible to attach a radar transmitter and a radar sensor to the moving part of the device, and for a reflecting device to be provided at the reference point to reflect the radar beams from the radar transmitter to the radar sensor.

The mechanical device can preferably be a lifting device with a mast and a cylinder that is capable of being moved largely vertically therein or thereon, the lift height of which is capable of being determined. For example, the fork of an industrial conveying vehicle can be held on the movable cylinder. With this proposed measurement arrangement having a radar system, the lift height at the lift mast and, therefore, the height of the fork of a fork lift, as the industrial conveying vehicle, are capable of being measured in advantageous fashion, whereby the knowledge of the lift height enables additional functions on these vehicles, such as safety functions or the automation of certain processes.

In simple fashion, the driving speed of the industrial conveying vehicle can be controlled, with consideration for the lift height, using a closed control loop, so that, for example, given a certain height of the fork of a fork lift, the speed of the vehicle can be reduced. It is also easily possible to automatically bring the vehicle into motion with a preselected lift height.

Furthermore, it is also possible in advantageous fashion for the pressure of the hydraulic fluid to be detected and evaluated for a hydraulic lifting device, in addition to the measurement of the lift height. Using a closed control loop, for example, with consideration for the pressure measurement and the measurement of the lift height, it is therefore possible to also consider the inclination of the lifting device and to therefore control the lifting velocity and/or tipping resistance of the lifting device in simple fashion. In this case, the weight of the load is detected here based on the pressure in the lift cylinder, then the acceleration of the inclination of the mast can be calculated as a function of the height and weight of the fork.

With the latter embodiment it is therefore advantageously possible for the lifting device to limit the acceleration of the extension of the cylinder of the lifting device when a specified angle of inclination of the mast of a fork lift has been exceeded. It is possible to also obtain an improvement of the tipping resistance of the fork lift by limiting the permitted torque around the pivot point of the mast, which can also be achieved by measuring the lift height and load via the pressure in the lift cylinder.

With a further advantageous embodiment, a closed control loop can be used to dampen vibrations of the industrial conveying vehicle by evaluating the pressure measurement and the measurement of lift height. When the invention is used in a fork lift, it is possible for the permissible torque of the lifting device to be dynamically exceeded on an uneven surface and with a relatively heavy load; this can result in the rear wheels of the fork lift coming off the ground. Due to the typical rear-wheel drive layout of the vehicle, this can result in impaired steerability. If the pressure peaks in the lift cylinder of the lifting device can now be specifically reduced, this behavior can be improved. To prevent the fork of the vehicle from being lowered impermissibly low toward the floor, a detection and evaluation of the actual lift height and/or the fork height is also advantageously feasible in this case with the arrangement according to the invention, e.g., using a superposed position control loop.

### DRAWING

An exemplary embodiment of the sensor arrangement according to the invention with a radar sensor for measuring the lift height of a lifting device for the fork of a fork lift is explained in the sole FIGURE in the drawing.

### DETAILED DESCRIPTION OF THE EMBODIMENT

The FIGURE shows a mast 1 of a lifting device 2 for a fork lift, as the industrial conveying vehicle, shown here only symbolically using a coordinate system 3 of its chassis. A cylinder 4 is capable of being extended hydraulically out of mast 1 of lifting device 2, whereby a traverse 5 is located at one end of mast 1, and a fork 6 is provided that is capable of being activated by lifting device 2 using a chain 14. Lifting device 2 is shown in a further coordinate system 7 with a pivot point 8, which can perform the tilting motions shown with arrows 9 and 10. The chassis of the vehicle is indicated using pivot points 11 with reference to the first coordinate system 3.

A sensor arrangement for measuring the lift height of extendable cylinder 4 is formed with an integrated radar transmitter and sensor 12 on mast 1 and with a triple reflector 13 on traverse 5 of extendable cylinder 4. Radar sensor 12 emits a microwave radar beam, for example, in the upward direction; it is reflected on triple reflector 13 and transmitted back to radar sensor 12 on mast 1.

The distance measurement that is carried out with the exemplary embodiment according to the invention in a manner that is known per se using radar beams therefore yields the lift height of cylinder 4 due to attachment of parts 12 and 13 of radar sensor arrangement and, therefore, also the height of fork 6, whereby parts 12 and 13 can also be mounted in the opposite arrangement. Since radar sensor 12 is permanently mounted on mast 1, according to the FIGURE, it follows mast 1 during inclination.

When, in accordance with an alternative that is not shown here, radar sensor 12 is attached to the chassis of the vehicle, this requires a broad angle of incoming radiation on the part of the radar transmitter, so that the reflected portion is still detected even when mast 1 tilts.

What is claimed is:

1. A sensor arrangement for measuring the deflection of a moving part of a mechanical device, with which
one part (13) of the contactless sensor arrangement is attached to the moving part (4), and another part (12) of the sensor arrangement is attached at a reference point for the device (2) wherein
a radar transmitter (12) and a radar sensor (12) are attached at the reference point of the device, and a reflector device (13) for reflecting the radar beams from the radar transmitter (12) to the radar sensor (12) is provided on the moving part (4), whereby the path of deflection of the moving part (4) of the mechanical device (2) is capable of being determined from the transit time of the radar beams.

2. A sensor arrangement for measuring the deflection of a moving part of a mechanical device, with which
one part (13) of the contactless sensor arrangement is attached to the moving part (4), and another part (12) of the sensor arrangement is attached at a reference point for the device (2) wherein
a radar transmitter (12) and a radar sensor (12) are attached to the moving part (4) of the device (2), and a reflector device (13) for reflecting the radar beams from the radar transmitter (12) to the radar sensor (12) is provided at the reference point, whereby the path of deflection of the moving part (4) of the mechanical device (2) is capable of being determined from the transit time of the radar beams.

3. The sensor arrangement as recited in claim 1, wherein
the mechanical device is composed of a lifting device (2) with a mast (1) and a cylinder (4) that is capable of being moved largely vertically therein or thereon, the lift height of which is capable of being determined.

4. The sensor arrangement as recited in claim 3,
wherein
the fork (6) of an industrial conveying vehicle is held on the movable cylinder (4).

5. The sensor arrangement as recited in claim 3 wherein
with a hydraulic lifting device (2), in addition to measuring the lift height, it is possible to detect and evaluate the pressure of the hydraulic fluid of the lifting device.

6. The sensor arrangement as recited in claim 5,
wherein
using a closed control loop, with consideration for the pressure measurement and the measurement of the lift height, it is possible to determine the inclination of the lifting device (2) and to control the lift velocity and/or the tipping resistance of the lifting device (2).

7. The sensor arrangement as recited in claim 4,
wherein
using a closed control loop, it is possible to control the driving speed of the industrial conveying vehicle, with consideration for the lift height.

8. The sensor arrangement as recited in claim 4,
wherein
using a closed control loop, it is possible to dampen vibrations of the industrial conveying vehicle by evaluating the pressure measurement and the measurement of lift height.

9. A method for operating a closed control loop as recited in claim 4,
wherein
to determine the absolute height of the lifting device, in particular the fork of an industrial conveying vehicle, the results of the lift height measurement, the pressure measurement, the measurement of the inclination angle of the lifting device, and the influences of the vehicle chassis and/or the drive wheels are used, and they are processed in a position control loop to control the lifting cylinder.

10. The method as recited in claim 9,
wherein
the target value for position is determined from a characteristic curve that is calculated based on the stored characteristics for the physical influences.
